(19) United States
(12) Patent Application Publication
(10) Pub. No.: US 2017/0085419 A1
(43) Pub. Date: Mar. 23, 2017

(54) SYSTEM AND METHOD FOR DEPLOYING AN APPLICATION

(71) Applicants: LE HOLDINGS (BEIJING) CO., LTD., Beijing (CN); LE CLOUD COMPUTING CO., LTD., Beijing (CN)

(72) Inventors: Jie ZHANG, Beijing (CN); Chao LI, Beijing (CN)

(21) Appl. No.: 15/219,657

(22) Filed: Jul. 26, 2016

Related U.S. Application Data
(63) Continuation of application No. PCT/CN2016/082908, filed on May 20, 2016.

(30) Foreign Application Priority Data
Sep. 18, 2015 (CN) 201510600160.4

(51) Int. Cl. H04L 12/24; H04L 12/911

(52) U.S. Cl. CPC H04L 41/082; H04L 41/5051; H04L 47/745; H04L 41/0806

(57) ABSTRACT

Embodiments of the invention provide a system and method for deploying an application, where service containers are deployed onto respective physical nodes in a cluster by firstly creating for a Service corresponding to the service, and deploying the service containers onto respective physical nodes in the cluster using the Service, so the respective service containers can know the service corresponding thereto so that they can be logically grouped on the service, and thus can be managed conveniently; and configuration parameters of the Service include the number of service containers, and a service container image, and the service containers can be deployed concurrently onto the respective physical nodes due to the characteristic of the service container image in the Docker, thus shortening the length of time taken to deploy the service containers in the cluster so as to improve the efficiency of deploying the service containers.

### CROSS-REFERENCE TO RELATED APPLICATION

This application is a continuation of International Application No. PCT/CN20161082908, filed on May 20, 2016, designating the United States, and claiming the benefit of Chinese Patent Application No. 201510600160.4, filed with the Chinese Patent Office on Sep. 18, 2015 and entitled “A system and method for deploying an application”, which is hereby incorporated by reference in its entirety.

### TECHNICAL FIELD

The present invention relates to the field of computer applications, and particularly to a system and method for deploying an application.

### BACKGROUND

The Docker is an open-source service container engine, and a developer can pack an application, and an environment upon which the application is dependent, into a portable service container, and then distributes the portable service container containing the packed application, and the environment upon which the application is dependent, onto any Linux machine, to virtualize the portable service container.

At present, any one service can be enforced by allocating the any one service onto a physical node in a cluster, where the physical node includes a container deployed thereon, and the physical node enforces the any one service through the container.

In the prior art, a container can be deployed by the Docker creating and deploying the container conveniently on a single physical node, but the Docker can not deploy containers rapidly and massively on respective physical nodes in the cluster concurrently. Additionally it may be difficult for the Docker deploying the containers to distinguish a service represented by one container from a service represented by another container, thus hindering the containers of the respective resources from being managed.

As can be apparent, if containers are deployed by the Docker on physical nodes as in the prior art, then such a problem may arise that the containers can not be deployed rapidly and massively on the respective physical nodes in the cluster concurrently, thus hindering the containers of the respective resources from being managed.

### SUMMARY

Embodiments of the invention provide a system and method for deploying an application so as to address such a problem may arise if containers are deployed by the Docker on physical nodes as in the prior art that the containers can not be deployed rapidly and massively on the respective physical nodes in the cluster concurrently, thus hindering the containers of the respective resources from being managed.

Particular technical solutions according to the embodiments of the invention are as follows:

An embodiment of the invention provides a method for deploying an application, the method including:
creating for any one application (APP) a Service corresponding to any one service in the any one APP, wherein the Service characterizes a set of service containers corresponding to the any one service;
configuring the Service with corresponding configuration parameters including the number of service containers, a cluster identifier, and a service container image corresponding to the Service, wherein the service container image includes an operating environment of the Service and an executing script of the Service;
obtaining the number of available resources in a cluster corresponding to the cluster identifier; and
if the number of available resources is above a preset threshold, then invoking the service container image corresponding to the Service according to the number of service containers to deploy the service containers onto respective physical nodes in the cluster corresponding to the cluster identifier.

An embodiment of the invention provides an apparatus or deploying an application, the method including:
a creating unit configured to create for any one application (APP) a Service corresponding to any one service in the any one APP, wherein the Service characterizes a set of service containers corresponding to the any one service;
a parameter configuring unit configured to configure the Service with corresponding configuration parameters including the number of service containers, a cluster identifier, and a service container image corresponding to the Service, wherein the service container image includes an operating environment of the Service and an executing script of the Service;
an available resource obtaining unit configured to obtain the number of available resources in a cluster corresponding to the duster identifier; and
a deploying unit configured, if the number of available resources is above a preset threshold, to invoke the service container image corresponding to the Service according to the number of service containers to deploy the service containers onto respective physical nodes in the cluster corresponding to the cluster identifier.

With the system and method for deploying an application according to the embodiments of the invention, for any one Application (APP), including at least one service a Service corresponding to any one service in the any one APP is created; the Service is configured with corresponding configuration parameters including the number of service containers, a cluster identifier, and a service container image corresponding to the Service, where the service container image includes an operating environment, and an executing script, of the Service; the number of available resources in a duster corresponding to the cluster identifier is obtained; and if the number of available resources is above a preset threshold, then the service container image corresponding to the Service is invoked according to a preset deployment strategy, and the number of service containers to deploy the service containers onto respective physical nodes in the cluster corresponding to the cluster identifier. With the technical solution according to the invention, the service containers can be deployed onto the respective physical nodes in the cluster by firstly creating for a service a Service corresponding to the service, and deploying the service containers onto respective physical nodes in the cluster using the Service, so the respective service containers can know the service corresponding thereto so that they can be logically grouped on the service, and thus can be managed conveniently; and the configuration parameters of the Service include the number of service containers, and the service container image, and the service containers can be deployed concurrently onto the respective physical nodes due to the characteristic of the service container image in the Docker, thus shortening the length of time taken to deploy the service containers in the cluster so as to improve the efficiency of deploying the service containers.

### BRIEF DESCRIPTION OF THE DRAWINGS

FIG. 1 is a flow chart of scheduling service containers according to a first embodiment of the invention;

FIG. 2 is a flow chart of creating an image according to a second embodiment of the invention;

FIG. 3 is a flow chart of scheduling service containers in a harbor system according to the second embodiment of the invention;

FIG. 4 is a schematic diagram of contents of a build.sh script according to the second embodiment of the invention;

FIG. 5 is a flow chart of upgrading a harbor system according to a third embodiment of the invention;

FIG. 6 is a flow chart of modifying the capacity of a harbor system according to a fourth embodiment of the invention;

FIG. 7 is a schematic structural diagram of an apparatus for scheduling a service container according to a fifth embodiment of the invention; and

FIG. 8 is a schematic structural diagram of an apparatus for scheduling a service container according to a sixth embodiment of the invention.

### DETAILED DESCRIPTION

In order to make the objects, technical solutions, and advantages of the embodiments of the invention more apparent, the technical solutions according to the embodiments of the invention will be described below clearly and fully with reference to the drawings in the embodiments of the invention, and apparently the embodiments described below are only a part but not all of the embodiments of the invention. Based upon the embodiments here of the invention, all the other embodiments which can occur to those skilled in the art without any inventive effort shall fall into the scope of the invention.

The embodiments of the invention will be described below in further details with reference to the drawings.

in an embodiment of the invention, a system for deploying an application includes: at least one pre-created cluster, each of which includes at least one physical node each representing a device; and a control device which can be a device separate from the cluster, or any one of the physical nodes in the cluster, and the system for deploying an application is embodied as a harbor system. A process of deploying an application (i.e., a service contain resource) will be described below in details by way of an example in which a system for deploying a service container includes only one cluster which includes a number of physical nodes.

### First Embodiment

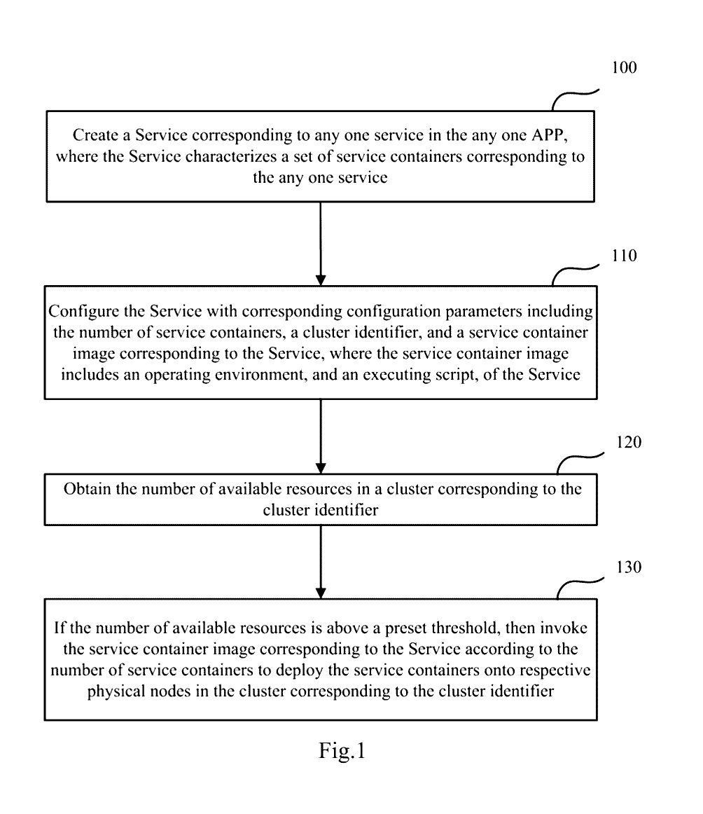

An APP can include a number of services, for example, an instant communication APP includes a taxi service, and other services, so for the sake of a convenient description, referring to FIG. 1, this embodiment of the invention will be described by way of an example in which a process of deploying an application is performed for any one of the services of the APP using a generated service container image, where the process includes the following steps:

The step 100 is to create a Service corresponding to any one service in the any one APP, where the Service characterizes a set of service containers corresponding to the any one service.

In an embodiment of the invention, a Service corresponding to the any one service is created, where the Service includes a number of service containers for providing the same service, and one Service corresponds to one image, so the same image applies to the service containers in the Service.

Optionally the Service is created by configuring the Service with corresponding descriptive information. The descriptive information includes a person responsible for the Service, a service description of the Service, the time when the Service is created, etc., so that the Service can be subsequently maintained, upgraded, etc.

Optionally the harbor system includes a scheduling module (marine) configured to provide a restapi interface to the outside, so that the harbor system creates the Service via the restapi interface of the scheduling module.

The step 110 is to configure the Service with corresponding configuration parameters including the number of service containers, a cluster identifier, and a service container image corresponding to the Service, where the service container image includes an operating environment of the Service and an executing script of the Service.

In an embodiment of the invention, the harbor system configures the Service with a corresponding number of service containers, a cluster identifier, and a service container image corresponding to the Service, where the service container image includes an operating environment of the Service and an executing script of the Service.

In an embodiment of the invention, since the harbor system can manage a number of clusters, the cluster identifier is set in the image so that it can determine onto physical nodes of which cluster the service containers to be allocated shall be deployed, and thus the harbor system can deploy the service containers reliably in the cluster.

Optionally if the harbor system includes the scheduling module (marine), then the harbor system may configure the Service with the corresponding configuration parameters via a Service interface or a Config interface of the scheduling module.

Furthermore the configuration parameters corresponding to the Service can further include a preset deployment strategy, and the preset deployment strategy includes a Harmonic Allocation (HA) strategy, and a Load-Balance strategy.

Furthermore the Service further includes network configuration information for configuring the service containers with fixed IP addresses, so that the service containers are provided with their own IP addresses.

Furthermore the harbor system includes an Etcd, and the Etcd is configured to store the Service and the configuration parameters thereof.

The step 120 is to obtain the number of available resources in a cluster corresponding to the cluster identifier.

In an embodiment of the invention, the harbor system obtains the number of available resources in a duster corresponding to the cluster identifier to determine whether to schedule the service containers in the cluster corresponding to the cluster identifier.

Optionally if the harbor system includes the scheduling module (marine), then the harbor system may obtain the number of available resources in the cluster corresponding to the cluster identifier via a Develop Service API interface of the scheduling module.

The step 130 is, if the number of available resources is above a preset threshold, to deploy the service containers onto respective physical nodes in the cluster corresponding to the cluster identifier by invoking the service container image corresponding to the Service according to the number of service containers.

In an embodiment of the invention, the harbor system obtains the preset deployment strategy upon determining that the number of available resources is above the preset threshold.

Particularly if the preset deployment strategy is the HA strategy, then the harbor system determines whether the cluster corresponding to the cluster identifier includes service containers in the Service; and if the cluster corresponding to the cluster identifier includes service containers in the Service, then the harbor system obtains a first configuration value corresponding to the service containers in the Service, and a second configuration value corresponding to the service containers in the cluster, and if the first configuration value is the same as the second configuration value, then the harbor system determines that the service containers in the cluster may not be updated, or if the first configuration value is different from the second configuration value, then the harbor system indicates that the service containers in the cluster needs to be re-deployed, and the harbor system allocates the service containers in the cluster equally onto the physical nodes in the cluster. If the duster corresponding to the cluster identifier includes no service containers in the Service, then the harbor system indicates that service containers need to be created in the cluster in response to a user instruction.

The service containers are deployed under the HA strategy so that all the service containers can be allocated equally onto the respective physical nodes to thereby avoid such a problem from arising that if all the service containers were allocated onto the same physical node, then the service would not have been enforced if the physical node failed, thus improving the reliability of providing the service.

Particularly if the preset deployment strategy is the Load-Balance strategy, then the harbor system determines whether the cluster corresponding to the cluster identifier includes service containers in the Service; and if the cluster corresponding to the cluster identifier includes service containers in the Service, then the harbor system obtains a first configuration value corresponding to the service containers in the Service, and a second configuration value corresponding to the service containers in the cluster, and if the first configuration value is the same as the second configuration value, then the harbor system determines that the service containers in the cluster does not need to be updated, or if the first configuration value is different from the second configuration value, then the harbor system indicates that the service containers in the cluster needs to be re-deployed, and the harbor system obtains the number of available resources on each physical node in the cluster; and allocates the service containers preferentially to the physical nodes with larger numbers of available resources in the cluster. If the cluster corresponding to the cluster identifier includes no service containers in the Service, then the harbor system indicates that service containers need to be created in the duster in response to a user instruction.

Optionally the configuration values are Message Digest Version 5 (MD5) values.

The service containers are deployed under the Load-Balance strategy so that a larger number of service containers can be distributed onto the physical nodes with larger number of available resources to thereby enable the physical nodes to enforce the service more efficiently so as to improve the efficiency of providing the service.

Furthermore after the harbor system selects the deployment strategy, the harbor system can invoke the service container image corresponding to the Service to deploy the service containers on respective physical nodes in a cluster corresponding to the cluster identifier, where the corresponding service container image is selected via an API interface or a portal interface provided by the harbor system to deploy the service containers.

With the technical solution according to the embodiment of the invention, the operating environment and the configuration information required for enforcing the Service can be packed into an image of a Docker command, and the service containers corresponding to the Service can be deployed without differentiating one service container from another due to the characteristic of the image, so that the service resources can be deployed each time simply by obtaining the corresponding image to thereby improve the efficiency of deploying the service containers.

### Second Embodiment

In an embodiment of the invention, the service container image is created before the service containers are deployed using the Service.

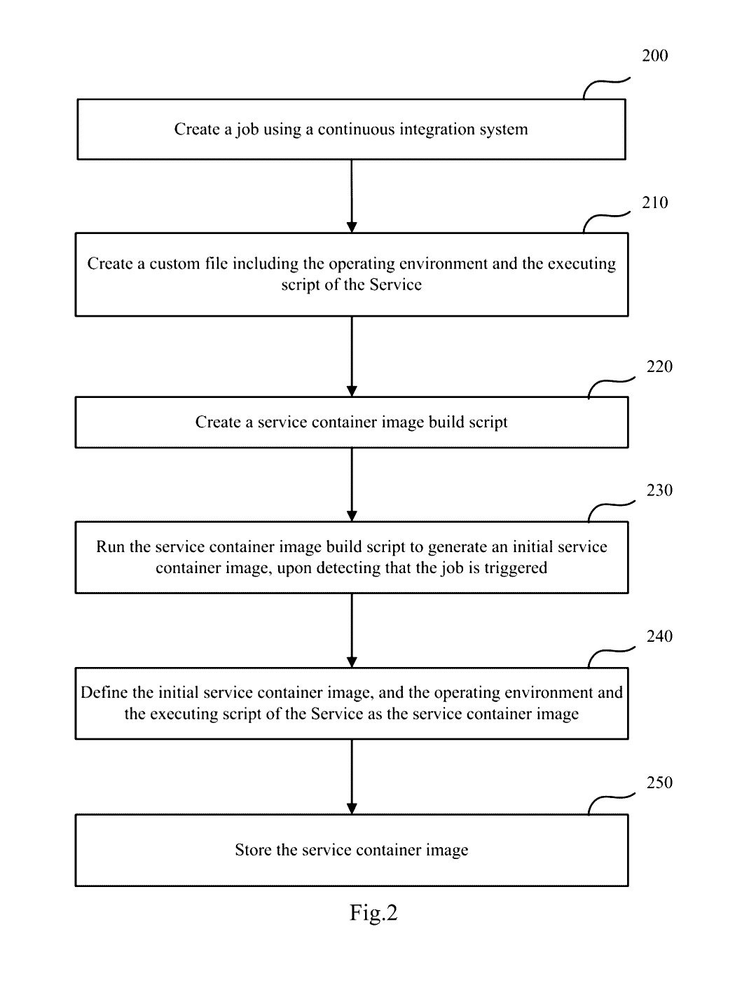

Referring to FIG. 2, a process of creating the service container image according to an embodiment of the invention includes the following steps:

The step 200 is to create a job using a continuous integration system.

In an embodiment of the invention, the service container image is created using a git and a continuous integration system (Jenkins).

Optionally the git is used as source code version control software of a project, and the git is configured by default to create two branches for the project, which are a Master branch and a Develop branch, where the Master branch is a primary branch including reliable codes, and the Develop branch is a secondary branch including codes in a test phase. Since the codes in the Develop branch can be developed by many developers, these codes is unreliable, so that the codes in the Develop branch can not be used as the codes in the Master branch unless the former codes have been tested without any error.

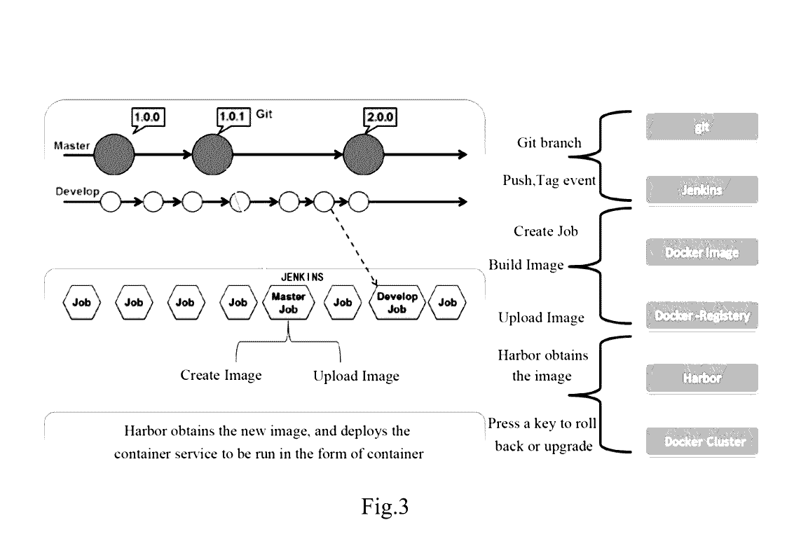

Furthermore referring to FIG. 3, the Jenkins creates a job for the Master branch (referred to as joba), and a job for the Develop branch (referred to as jobb), which are created by the git. The Jenkins hooks a push event or a tag event respectively on the Master branch and the Develop branch.

The step 210 is to create a custom file including the operating environment and the executing script of the Service.

In an embodiment of the invention, the git creates a custom file for the project (referred to as a Dockerfile file), the custom file defines the operating environment, and the executing script, e.g., a start script, of the Service. The Dockerfile file can define the operating environment (e.g., Java, nginx, etc.) required for running the application into the image.

The step 220 is to create a service container image build script.

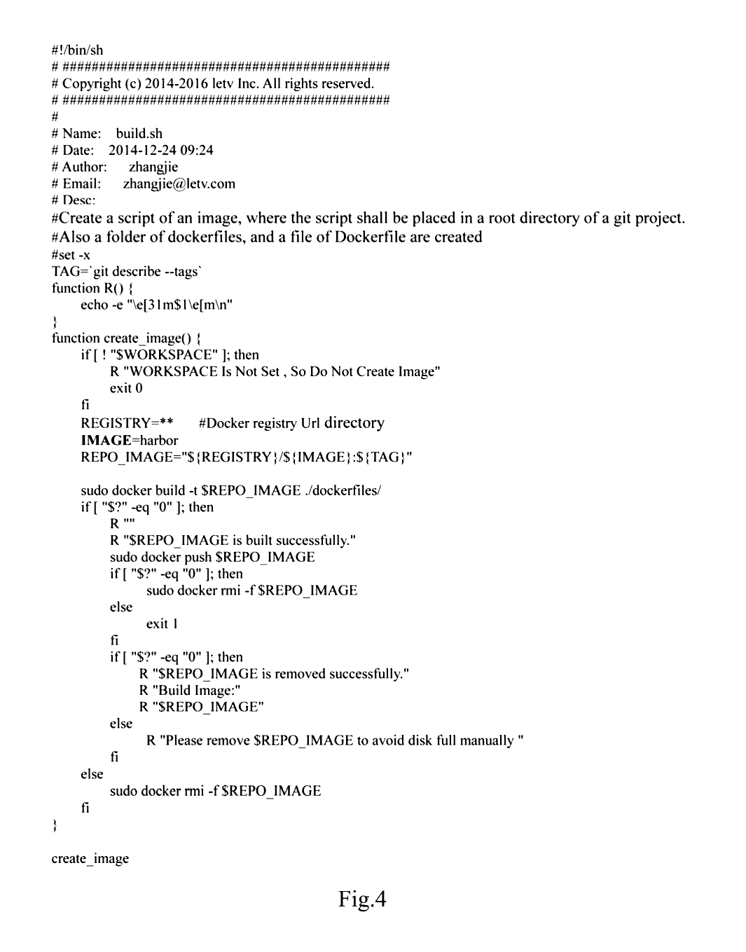

In an embodiment of the invention, a service container image build script (referred to as a build.sh script) is added to the project, where the build.sh script is configured to generate an initial service container image, and the build.sh scrip is located in a root directory of the project. FIG. 4 illustrates a schematic diagram of contents of the build.sh scrip according to an embodiment of the invention.

The step 230 is to run the service container image build script to generate an initial service container image, upon detecting that the job is triggered.

In an embodiment of the invention, since the Jenkins creates the joba corresponding to the Master branch, and the jobb corresponding to the Develop branch, different initial service container images are generated for the different jobs being triggered.

Particularly if the joba or joba is triggered, then the build.sh script is run. During the build.sh script is being run, the build.sh script defines a name for the service container image (referred to as an image name) according to the software version of the git; and additionally the build.sh script includes a Docker command to create the initial service container image.

The step 240 is to define the initial service container image, and the operating environment and the executing script of the Service as the service container image.

The step 250 is to store the service container image.

In an embodiment of the invention, after the image is created successfully, the Jenkins stores (pushes) the image into a Docker-registery using the Docker command, where the Docker-registery is a storage system in which the image is stored.

### Third Embodiment

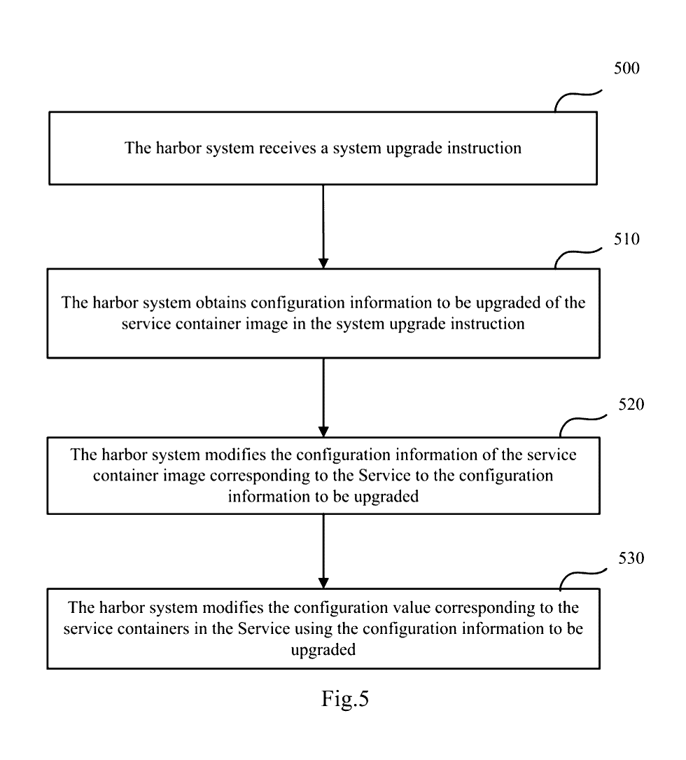

Further to the harbor system, referring to FIG. 5, a process of upgrading the harbor system according to an embodiment of the invention includes:

In the step 500, the harbor system receives a system upgrade instruction.

In an embodiment of the invention, the harbor system can receive the system upgrade instruction transmitted by the user, and detects whether the local system version is the latest version, and if not, then the harbor system starts system upgrade operations, where there may be a harbor system application server configured to store the application of the harbor system and a version number thereof.

Optionally the harbor system can receive the system upgrade instruction transmitted by the harbor system application server, and perform the system upgrade operations in response to the system upgrade instruction.

In the step 510, the harbor system obtains configuration information to be upgraded of the service container image in the system upgrade instruction.

In an embodiment of the invention, since the harbor system being upgraded means that the service container image corresponding to the Service is upgraded, the system upgrade instruction includes the configuration information to be upgraded of the service container image; and the harbor system is upgraded using the configuration information to be upgraded of the service container image.

In the step 520, the harbor system modifies the configuration information of the service container image corresponding to the Service to the configuration information to be upgraded.

In the step 530, the harbor system modifies the configuration value corresponding to the service containers in the Service using the configuration information to be upgraded.

In an embodiment of the invention, since the configuration value corresponding to the service containers include a part of the configuration information of the image, the configuration information of the image is changed so that the configuration value corresponding to the service containers are changed; and if the configuration information of the service container image corresponding to the Service is modified, then the configuration value corresponding to the service containers in the Service needs to be modified using the configuration information to be upgraded.

With the technical solution according to the embodiment of the invention, the version of the harbor system can be rapidly and conveniently modified simply by modifying the configuration information of the image; and if there is an error occurring in the upgraded harbor system, then the harbor system can be rolled rapidly back to the last version to thereby alleviate in effect a loss arising from the upgrade error.

### Fourth Embodiment

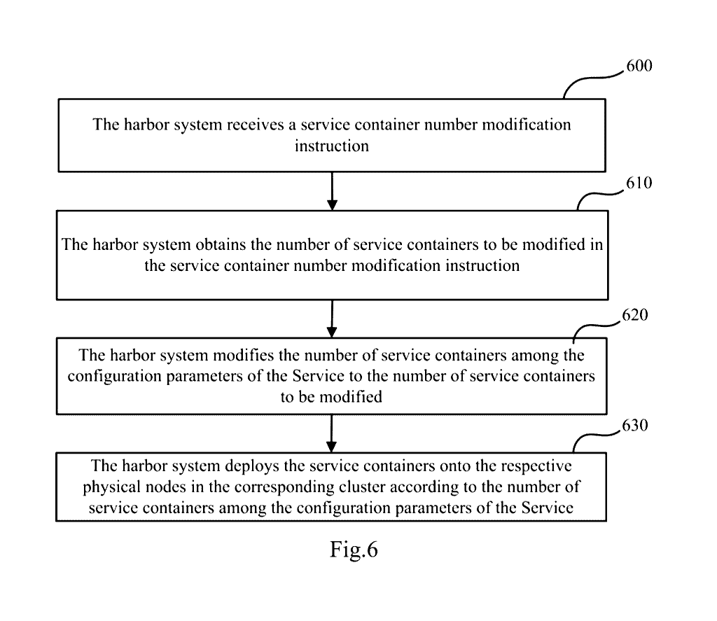

Further to the harbor system, referring to FIG. 6, a process of modifying the number of service containers in the harbor system according to an embodiment of the invention includes the following steps:

In the step 600, the harbor system receives a service container number modification instruction.

In an embodiment of the invention, if the service corresponding to the Service is heavily loaded then the harbor system needs to be extended in capacity in order to improve the quality of service in the harbor system; and correspondingly if the service corresponding to the Service is lightly loaded, then the harbor system needs to be narrowed in capacity in order to reduce the number of resources occupied in the harbor system, and the consumption in the system.

Optionally the harbor system can receive the service container number modification instruction transmitted by the user, and be extended or narrowed in capacity in response to the service container number modification instruction; or the harbor system can receive the service container number modification instruction transmitted by another device, and be extended or narrowed in capacity in response to the service container number modification instruction.

In the step 610, the harbor system obtains the number of service containers to be modified in the service container number modification instruction.

In the step 620, the harbor system modifies the number of service containers among the configuration parameters of the Service to the number of service containers to be modified.

In an embodiment of the invention, the harbor system modifies the number of service containers among the configuration parameters of the Service to the number of service containers to be modified, invokes a deploy service API interface of the scheduling module to re-deploy the service containers as described in the solution according to the first embodiment.

In the step 630, the harbor system invokes the service container image corresponding to the Service according to the service container number to be modified to deploy the service containers onto respective physical nodes in the cluster corresponding to the cluster identifier.

With the technical solution according to the embodiment of the invention, the harbor system can be conveniently extended and narrowed in capacity simply by modifying the number of service containers to thereby improve in effect the operability and the flexibility of the harbor system.

### Fifth Embodiment

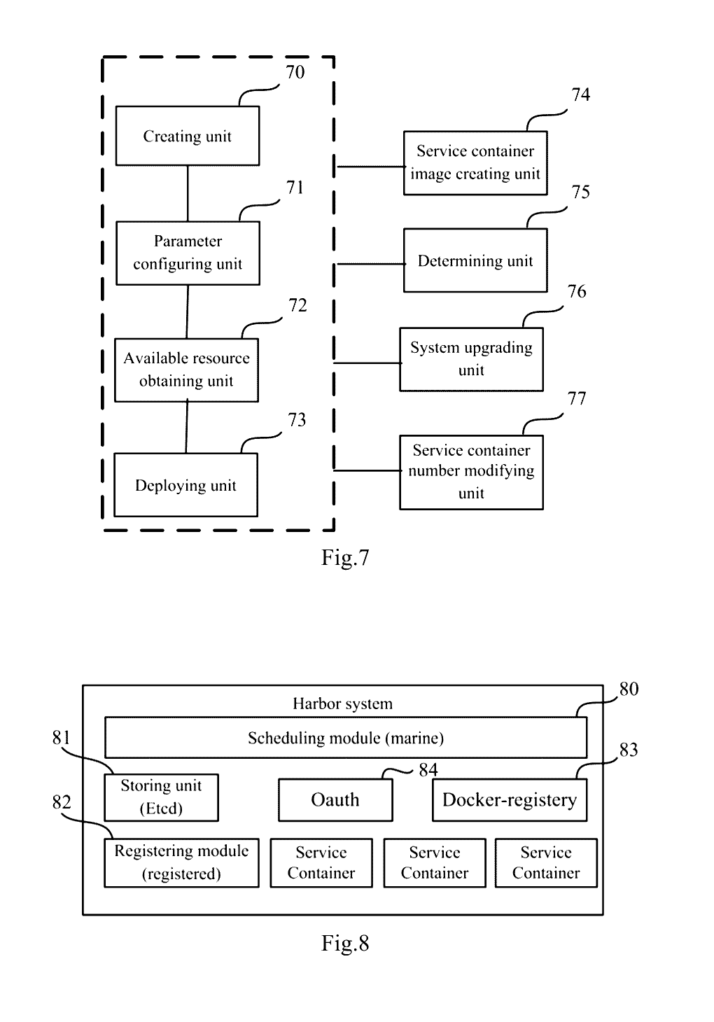

Further to the technical solution above, referring to FIG. 7, an embodiment of the invention provides an apparatus for deploying an application, which includes a creating unit 70, a parameter configuring unit 71, an available resource Obtaining unit 72, and a deploying unit 73, where:

The creating unit 70 is configured to create for any one application (APP) a Service corresponding to any one service in the any one APP, where the Service characterizes a set of service containers corresponding to the any one service;

The parameter configuring unit 71 is configured to configure the Service with corresponding configuration parameters including the number of service containers, a cluster identifier, and a service container image corresponding to the Service, where the service container image includes an operating environment of the Service and an executing script of the Service;

The available resource obtaining unit 72 is configured to obtain the number of available resources in a cluster corresponding to the cluster identifier; and

The deploying unit 73 is configured, if the number of available resources is above a preset threshold, to invoke the service container image corresponding to the Service according to the number of service containers to deploy the service containers onto respective physical nodes in the cluster corresponding to the cluster identifier.

Optionally the configuration parameters further include a preset deployment strategy corresponding to the Service; and the deploying unit 73 is configured to deploy the service containers onto the respective physical nodes in the cluster corresponding to the cluster identifier according to the preset deployment strategy.

Furthermore the system further includes a service container image creating unit 74 configured to create a job using a continuous integration system; to create a custom file defining the operating environment and the executing script of the Service; to create a service container image build script; to run the service container image build script to generate an initial service container image, upon detecting that the job is triggered; to define the initial service container image, and the operating environment and the executing script of the Service as the service container image; and to store the service container image.

Furthermore the system further includes a determining unit 75 configured: to determine that the cluster corresponding to the cluster identifier includes service containers in the Service, and a configuration value corresponding to the service containers in the Service is different from a configuration value corresponding to the service containers in the Service included in the cluster corresponding to the cluster identifier, before the service containers are deployed onto the respective physical nodes in the duster corresponding to the duster identifier, where the configuration value corresponding to the service containers characterizes a parameter required for starting the service.

Furthermore the system further includes a system upgrading unit 76 configured: to receive a system upgrade instruction; to obtain configuration information to be upgraded of the service container image in the system upgrade instruction; to modify configuration information of the service container image corresponding to the Service to the configuration information to be upgraded; and to modify a configuration value corresponding to the service containers in the Service using the configuration information to be upgraded.

Furthermore the system further includes a service container number modifying unit 77 configured: to receive a service container number modification instruction; to obtain the number of service containers to be modified in the service container number modification instruction; to modify the number of service containers among the configuration parameters of the Service to the number of service containers to be modified; and to invoke the service container image corresponding to the Service according to the number of service containers to be modified, to deploy the service containers onto the respective physical nodes in the cluster corresponding to the cluster identifier.

### Sixth Embodiment

Further to the technical solution above, referring to FIG. 8, an embodiment of the invention provides a system for deploying an application, which is configured to deploy service container resources after a Service is created, and which is embodied as a harbor system including a scheduling unit (marine) 80, a storing unit (Etcd) 81, and a registering module (registered) 82, where:

The scheduling unit 82 is configured, if the number of available resources in a duster is above a preset threshold, to invoke a service container image corresponding to the Service according to a preset deployment strategy and the number of service containers, to deploy the service containers onto respective physical nodes in a cluster corresponding to a cluster identifier;

The storing unit 81 is configured to store an APP, the service containers, configuration information of the physical nodes, etc., where the storing unit 81 is an open-source highly available key value storing component, the storing unit 81 is configured to enable the configuration and the service to be shared, and the storing unit 81 is developed and maintained by CoreOS; and

The registering module 82 is configured to register the newly created service containers into the storing unit 81, where the registering module 82 is a proxy operating on a Docker host.

Furthermore the system further includes a Docker-registery module 83 configured to store the image.

Furthermore the system further includes an oauth module 84 configured to authenticate all of instructions invoking a harbor system interface.

In summary, in the embodiments of the invention, a Service corresponding to any one service in the any one APP is created; the Service is configured with corresponding configuration parameters including the number of service containers, a cluster identifier, and a service container image corresponding to the Service, where the service container image includes an operating environment, and an executing script, of the Service; the number of available resources in a cluster corresponding to the cluster identifier is obtained; and if the number of available resources is above a preset threshold, then the service container image corresponding to the Service is invoked according to a preset deployment strategy, and the number of service containers to deploy the service containers onto respective physical nodes in the duster corresponding to the cluster identifier. With the technical solution according to the invention, the service containers can be deployed onto the respective physical nodes in the cluster by firstly creating for a service a Service corresponding to the service, and deploying the service containers onto respective physical nodes in the cluster using the Service, so the respective service containers can know the service corresponding thereto so that they can be logically grouped on the service, and thus can be managed conveniently; and the configuration parameters of the Service include the number of service containers, and the service container image, and the service containers can be deployed concurrently onto the respective physical nodes due to the characteristic of the service container image in the Docker, thus shortening the length of time taken to deploy the service containers in the cluster so as to improve the efficiency of deploying the service containers.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the invention. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the invention; and although the invention has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the invention as claimed.

What is claimed is:

1. A method for deploying an application, the method comprising:
creating for any one application (APP) a Service corresponding to any one service in the any one APP, wherein the Service characterizes a set of service containers corresponding to the any one service;
configuring the Service with corresponding configuration parameters comprising the number of service containers, a duster identifier, and a service container image corresponding to the Service, wherein the service container image comprises an operating environment of the Service and an executing script of the Service;
obtaining the number of available resources in a duster corresponding to the duster identifier; and
if the number of available resources is above a preset threshold, then invoking the service container image corresponding to the Service according to the number of service containers to deploy the service containers onto respective physical nodes in the cluster corresponding to the cluster identifier.

2. The method according to claim 1, wherein the configuration parameters further comprise a preset deployment strategy corresponding to the Service; and
deploying the service containers onto the respective physical nodes in the cluster corresponding to the cluster identifier comprises:
deploying the service containers onto the respective physical nodes in the cluster corresponding to the cluster identifier according to the preset deployment strategy.

3. The method according to claim 1, wherein creating the service container image corresponding to the Service comprises:
creating a job using a continuous integration system;
creating a custom file defining the operating environment and the executing script of the Service;
creating a service container image build script;
running the service container image build script to generate an initial service container image, upon detecting that the job is triggered;
defining the initial service container image, and the operating environment and the executing script of the Service as the service container image; and storing the service container image.

4. The method according to claim 1, wherein before the service containers are deployed onto the respective physical nodes in the cluster corresponding to the cluster identifier, the method further comprises:
determining that the cluster corresponding to the cluster identifier comprises service containers in the Service, and a configuration value corresponding to the service containers in the Service is different from a configuration value corresponding to the service containers in the Service in the cluster corresponding to the cluster identifier,
wherein the configuration value corresponding to the service containers characterizes a parameter required for starting the service.

5. The method according to claim 1, wherein the method further comprises:
receiving a system upgrade instruction;
obtaining configuration information to be upgraded of the service container image in the system upgrade instruction;
modifying configuration information of the service container image corresponding to the Service to the configuration information to be upgraded; and
modifying a configuration value corresponding to the service containers in the Service using the configuration information to be upgraded.

6. The method according to claim 1, wherein the method further comprises:
receiving a service container number modification instruction;
obtaining the number of service containers to be modified in the service container number modification instruction;
modifying the number of service containers among the configuration parameters of the Service to the number of service containers to be modified; and
invoking the service container image corresponding to the Service according to the number of service containers to be modified, to deploy the service containers onto the respective physical nodes in the cluster corresponding to the cluster identifier.

7. The method according to claim 2, wherein the method further comprises:
receiving a system upgrade instruction;
obtaining configuration information to be upgraded of the service container age in the system upgrade instruction;
modifying configuration information of the service container image corresponding to the Service to the configuration information to be upgraded; and
modifying a configuration value corresponding to the service containers in the Service using the configuration information to be upgraded.

8. The method according to claim 3, wherein the method further comprises:
receiving a system upgrade instruction;
obtaining configuration information to be upgraded of the service container image in the system upgrade instruction;
modifying configuration information of the service container image corresponding to the Service to the configuration information to be upgraded; and
modifying a configuration value corresponding to the service containers in the Service using the configuration information to be upgraded.

9. The method according to claim 4, wherein the method further comprises:
receiving a system upgrade instruction;
obtaining configuration information to be upgraded of the service container image in the system upgrade instruction;
modifying configuration information of the service container image corresponding to the Service to the configuration information to be upgraded; and
modifying a configuration value corresponding to the service containers in the Service using the configuration information to be upgraded.

10. The method according to claim 2, wherein the method further comprises:
receiving a service container number modification instruction;
obtaining the number of service containers to be modified in the service container number modification instruction;
modifying the number of service containers among the configuration parameters of the Service to the number of service containers to be modified; and
invoking the service container image corresponding to the Service according to the number of service containers to be modified, to deploy the service containers onto the respective physical nodes in the cluster corresponding to the cluster identifier.

11. The method according to claim 3, wherein the method further comprises:
receiving a service container number modification instruction;
obtaining the number of service containers to be modified in the service container number modification instruction;
modifying the number of service containers among the configuration parameters of the Service to the number of service containers to be modified; and
invoking the service container image corresponding to the Service according to the number of service containers to be modified, to deploy the service containers onto the respective physical nodes in the cluster corresponding to the cluster identifier.

12. The method according to claim 4, wherein the method further comprises:
receiving a service container number modification instruction;
obtaining the number of service containers to be modified in the service container number modification instruction;
modifying the number of service containers among the configuration parameters of the Service to the number of service containers to be modified; and
invoking the service container image corresponding to the Service according to the number of service containers to be modified, to deploy the service containers onto the respective physical nodes in the cluster corresponding to the cluster identifier.

13. A system for deploying an application, the system comprising:
a creating unit configured to create for any one application (APP) a Service corresponding to any one service in the any one APP, wherein the Service characterizes a set of service containers corresponding to the any one service;
a parameter configuring unit configured to configure the Service with corresponding configuration parameters comprising the number of service containers, a cluster identifier, and a service container image corresponding to the Service, wherein the service container image comprises an operating environment of the Service and an executing script of the Service;
an available resource obtaining unit configured to obtain the number of available resources in a cluster corresponding to the duster identifier; and
a deploying unit configured, if the number of available resources is above a preset threshold, to invoke the service container image corresponding to the Service according to the number of service containers to deploy the service containers onto respective physical nodes in the cluster corresponding to the cluster identifier.

14. The system according to claim 13, wherein the configuration parameters her comprise a preset deployment strategy corresponding to the Service; and
the deploying unit is configured:
to deploy the service containers onto the respective physical nodes in the cluster corresponding to the cluster identifier according to the preset deployment strategy.

15. The system according to claim 13, wherein the system further comprises a service container image creating unit configured:
to create a job using a continuous integration system;
to create a custom file defining the operating environment and the executing script of the Service;
to create a service container image build script;
to run the service container image build script to generate an initial service container image, upon detecting that the job is triggered;
to define the initial service container image, and the operating environment and the executing script of the Service as the service container image; and
to store the service container image.

16. The system according to claim 13, wherein the system further comprises a determining unit configured:
before the service containers are deployed onto the respective physical nodes in the cluster corresponding to the cluster identifier, to determine that the cluster corresponding to the cluster identifier comprises service containers in the Service, and a configuration value corresponding to the service containers in the Service is different from a configuration value corresponding to the service containers in the Service in the cluster corresponding to the cluster identifier,
wherein the configuration value corresponding to the service containers characterizes a parameter required for starting the service.

17. The system according to claim 13, wherein the system further comprises a system upgrading unit configured:
to receive a system upgrade instruction;
to obtain configuration information to be upgraded of the service container image in the system upgrade instruction;
to modify configuration information of the service container image corresponding to the Service to the configuration information to be upgraded; and
to modify a configuration value corresponding to the service containers in the Service using the configuration information to be upgraded.

18. The system according to claim 13, wherein the system further comprises a number-of-service-containers modifying unit configured:
to receive a service container number modification instruction;
to obtain the number of service containers to be modified in the service container number modification instruction;
to modify the number of service containers among the configuration parameters of the Service to the number of service containers to be modified; and
to invoke the service container image corresponding to the Service according to the number of service containers to be modified, to deploy the service containers onto the respective physical nodes in the cluster corresponding to the cluster identifier.
